(19) United States
(12) Patent Application Publication
(10) Pub. No.: US 2009/0063544 A1
(43) Pub. Date: Mar. 5, 2009

(54) Managing Mobile Classroom Data

(76) Inventors: Brett W. Jameson, Boise, ID (US); Ezekiel T. Messenger, Boise, ID (US)

Correspondence Address: TECHNOLOGY LAW GROUP, PLLC, 776 East Riverside Drive, Ste 200-204, Eagle, ID, 83616, US

(21) Appl. No.: 11/850,176

(22) Filed: Sep. 5, 2007

(51) Int. Cl. G06F 17/30

(52) U.S. Cl. 707/102; 707/E17.005

(57) ABSTRACT

A system for managing classroom data using both improved data collection techniques within the classroom, and superior data preservation techniques for preserving data associated with a mobile population that spans across geographic boundaries.

### BACKGROUND OF THE INVENTION

This invention relates to the field of collecting and managing classroom data associated with a mobile student and teacher population.

Numerous computer based systems exist to assist teacher and school administrators to collect and manage data related to the classroom and to the student. In recent years, because of the proliferation of the internet, such systems are often web-based. Because of the emphasis and reporting requirements of recent Federal legislation such as the “No Child Left Behind” act, school administrators are highly motivated—an in many cases compelled—to collect, manage, and analyze significant amounts of student data, and produce reports consistent with both local and national reporting requirements. Most states have their own reporting requirements. For example, in New York, such requirements are codified by the Local Education Agency (LEAP).

While many such systems have been deployed, they all tend to suffer from drawbacks in two areas: (1) the collection and entry of classroom related data and (2) the preservation of collected data when dealing with a mobile student and teacher population. To work effectively, such systems depend heavily on data being both accurately and timely collection and data entry of pertinent data. Reporting responsibility generally resides with school administrators, but the task of collecting and managing the raw data is more often than not in the realm of the classroom teacher, who determines attendance, issues assignments, distributes classroom material, and performs grading. The drawback of present systems is that they are generally very difficult for classroom teachers to use, particularly for skilled teachers that have neither the time nor the inclinations to learn the nuances of prior art software systems that are often to be perceived to be a burden, rather than a helpful resource, to the teacher's primarily responsibility of instructing students.

Another difficult with effective management of student data is maintaining data integrity in a mobile student population. It is often the case that when a student moves to a new area, the data associated with the student at the old school is archived or lost, and the student is treated as a new student in the new school and new records are created for the student without the benefit of existing student records at previous schools. This chaotic situation results in a system with large amounts of both incomplete and redundant student data.

What is needed is a better system that enables teachers and administrators to effectively manage classroom data, and allows the data to be migrated with students who are members of a mobile student population.

### BRIEF SUMMARY OF THE INVENTION

The present system solves the problems cited above and provides new and unobvious benefits. The present inventions departs from the prior art method using traditional data collection methods, and instead teaches both an improved data collection technique within the classroom, and superior data preservation for a mobile population that spans across geographic boundaries. With respect to classroom data collection and management, the present invention teaches a new paradigm where classroom data is organized around data objects, and the low-level data objects are represented in a graphical user environment by icons familiar to teachers, including those teachers who are not computer experts. In one embodiment, data objects types are defined for an instruction course, another for teachers, and another for students. Graphical icons are designed to represent data objects of each type (students, teachers, and instructional courses). Basic data management operations can be managed by “dragging and dropping” icons on to each other in meaningful ways. The present invention teaches the extensive use of organizing classroom data into meaningful lists, and representing both the low level data items and the lists as graphical icons. For example, a student can be added to a course (which can be represented as including a list of students) by dragging an icon representing the student onto an instructional course icon by a teacher or administrator and that student is thereby added to the class.

In the present invention, for data collection and administrative purposes, the world is logically organized into administrative units, arrangement in a hierarchy. The primary unit is a school. Within the school are numerous instructional courses, each having students and one or more teachers. Schools are typically organized into school districts, and in the United States, there are typically multiple school districts within a state.

In the present invention, to avoid the potentially ambiguous term “class”, the term “instructional course” is used to denote each classroom of students and teacher(s) in a single section of a particular course. The term also applies herein to an elementary school classroom setting where typically multiple subjects are taught to the same class. The present invention teaches associating a data object with each participant and the instructional course itself, and organizing the data objects into lists that are then associated with higher nodes in the hierarchy. In the preferred embodiment a list of student data objects represents the students taking a particular course and the list is associated with an instructional course data object. Analogously, a list of teachers is also associated with an instructional class, although frequently the list has only one member, representing a single teacher assigned to teach the particular course.

The present system recognizes that the population of a school, including both students and faculty, are mobile, and that the data associated with a student or teacher needs to be ale to be easily moved with that student of teacher as they migrate to different geographical area. This is achieved by organizing the classroom data into a hierarchical tree representing geographic entitles. Such as states, school districts, schools, and classrooms. Associated with each level of the hierarchy is a security token that allows an authorized individual at that level to manage the data within his or her associated realm. For example, a when a student transfers between schools within a district, a properly authorized school district official is able to move the student and its associated data to the new school. However, a teacher from either school would lack the authority to make such a move; only security tokens superior to both entities within the hierarchy can move the data. Thus, in this example, only an authorized state official could move a student between schools in different school districts within a state.

For an interstate move, a person authorized higher than the state (multi-state or national for example) we be authorized and could perform the move. The invention also provides for a super administrator that is authorized for the entire hierarchy, but it is contemplated that this authority would be exercised only for exceptional cases.

### BRIEF DESCRIPTIONS OF THE DRAWINGS

FIG. 1 shows generally a typical hierarchy of personnel responsible for classroom data according to the present invention.

FIG. 2 generally a typical hierarchy of personnel responsible for classroom and further illustrates the changes in the hierarchy required when a student moves to a new district data according to the present invention.

FIG. 3 depicts generally typical data object icons consistent with the present invention.

### DETAILED DESCRIPTION OF THE INVENTION

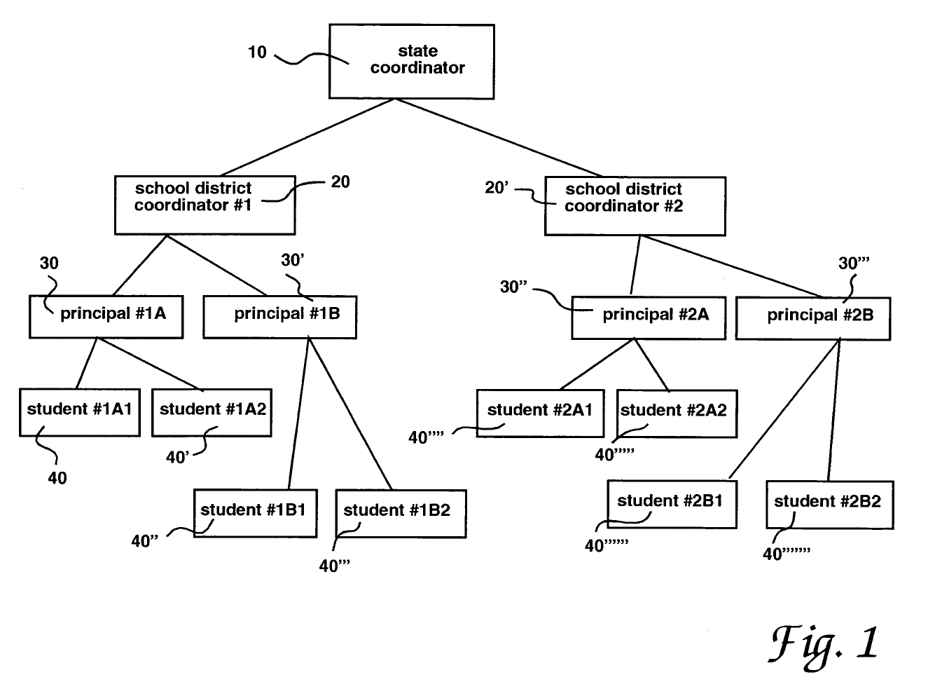

FIG. 1 generally shows a typical hierarchy of nodes that illustrates the organization taught by the present invention. Referring to FIG. 1, the root of this hierarchy is the U.S. state coordinator 10. In typical systems, there are additional layers of hierarchy such as multi-state and national coordinators which were not included in FIG. 1 for brevity. The school district coordinator nodes 20 are child nodes of the state coordinator 10 and conversely, the state coordinator 10 is the parent node of each school district coordinator 20 node. Similarly, the principal nodes 30 are child nodes of the school district coordinator nodes 20 and the student nodes 40 are children of the principal nodes 30. It instructive to node that the principal nodes 30 could have been labeled school nodes with the same effect, the implication being that each school in this example has a unique principal 30 so that it is reasonable, but not required to identify the school by principal 30. It is further instructive to note that different school districts and different states may in fact use different names and have different hierarchies, and the specific names used in FIG. 1 are for illustration, and are not meant in any way to limit the invention. The nodes can be named using a variety of useful conventions.

Associated with each node (not shown) is a security token that contains authentication information. In one embodiment, the authentication information is a name and a password couplet unique to that node. Thus the actual authority may rest with one school administrator such as a principal 30, but he or she can authorize another employee, typically a subordinate, to, for the purposes of the present invention, interface with the system and move data nodes as required to reflect actual changes in the moving populations, which, in this example, consists primarily students 40.

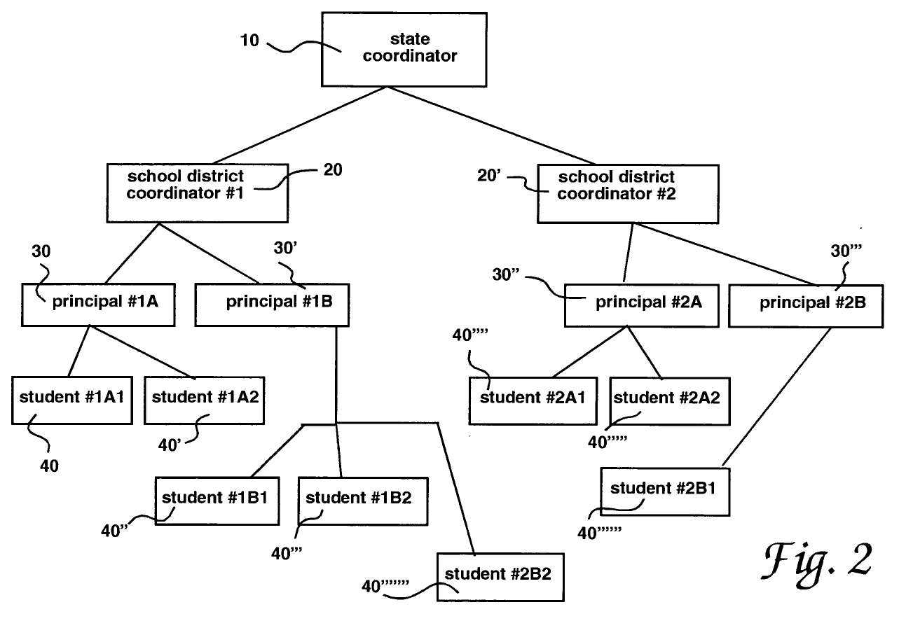

Moving a student 40 to anther school involves changing the parent node of the particular student node. For example, in FIG. 1, if student # 40′″″″ (#2B2) moved to the school of principle 30′ (#1B), the change would be effected by changing the parent node of the effected student node to reflect the new school/principle 30 as shown in FIG. 2.

The particularly inventive aspect of FIG. 1 and FIG. 2 is the inclusion of security tokens in each node that allow the administrator of that node level to enter any and all appropriate changes to the dataset that involve descendants of the node. In concerns involving mobile populations such as school systems, the population crosses numerous legal and geographical boundaries, so that there is generally no entity that manages the population as a whole, particularly above the state level. By designing and implementing an appropriate hierarchy as taught herein, and providing appropriate security tokens to each node as taught herein provides essential structure. For the purposes of data management, structure is thus imposed on a system lacking structure, and important functions, such as preserving student data when a student moves out of a school district, perhaps to another state, can now be efficiently done when deploying the applicant's claimed invention, despite the lack of formal governmental structure at each level.

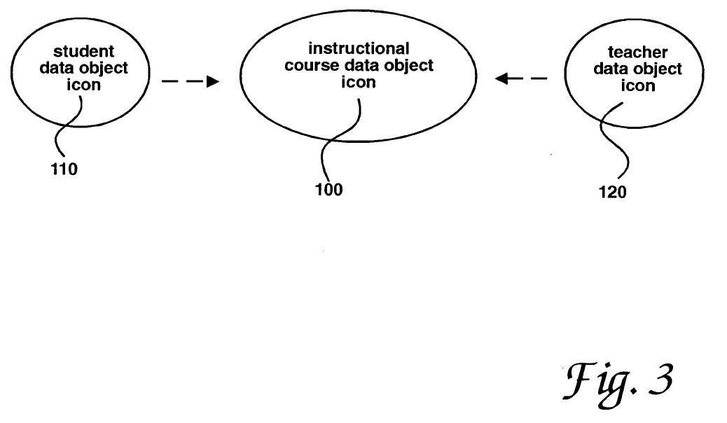

The system of FIGS. 1 and 2 is particularly useful when student data is accurately collected and maintained at the school level, particularly inside the classroom, using the present invention. Prior art systems rely on clumsy database entry systems that typically rely on deploying computer proficient technicians to enter the data. Unfortunately, the reality for most schools is that they lack the resources employed dedicated technicians for such purposes and thus the burden to collecting and maintaining the student data in reality often falls onto the shoulders of teachers who often are skilled teachers but who often lack the technical expertise to interface with prior art database systems. The present invention solves this problem by representing low level data objects as user-friend visual icons familiar to all teachers. Referring to FIG. 3, a typical embodiment of the present system includes an instructional course icon 100 for each low-level instruction class data objects, a unique visual student icon representing each low-level student data object 110—course icon 100 and a visual teacher icon 120 representing each low-level teacher data object. Using the present invention, a student can be moved to a particular course by dragging the appropriate student icon 110 onto the instructional course icon 100. This can easily be done by a computer novice. Likewise, changes in teacher assignments can be reflected in the system by dragging the appropriate teacher icon 120 and dropping it onto the instructional course icon 100, again achievable by a computer novice. Thus, with the present invention, accurate data is more frequently collected and maintained because the system, unlike prior art systems, recognizes that computer novice teachers, rather than computer technicians, will play a primary role in moving and maintaining data to reflect routine changes in class lists. This invention is not limited to students, teachers, and instructional classes, virtually any classroom data set, such as grading data, demographic data, attendance data, and the like can be organized and present according to the teachings of the present inventions and also achieve the benefits of the present invention that are lacking in prior art systems.

When an accurate dataset is maintained as described herein, and the data can be efficiently and securely moved as also taught herein, the resulting overall system is a widespread, integrated set of classroom data correctly collected and preserved and securely transferred across diverse and distant schools and school districts.

The embodiments described above are provided for illustration, not limitation. As one skilled in the art will appreciate, the invention is useful in analogous settings. For example, the preferred embodiment is deployable across states of the United States, but the technology is also useful in virtually any geographical system such as Canadian provinces. Furthermore, the exact nature of the data to be collected or preserved is not limited to strictly classroom structures, and in fact, can be designed by, each school or school district to reflect local administrative requirements and practices. The invention is only limited by the claims as set forth below.

I claim:

1. A system for managing mobile classroom data comprising:
a database of classroom data,
the database of classroom data further includes a hierarchy of child nodes including a root node, each child node has an associated classroom data object, each child node of the hierarchy, except the root node, identifies another child node in the dataset as its parent node,
each child node further includes a security token, the security token further includes authorization codes, wherein a user that presents said authorization codes is authorized to move data related to any and all descendant child nodes.

2. The system of claim 1 further comprising:
a graphical user interface,
the database of classroom data further includes a list of one or more first classroom data objects,
said graphical user interface further includes a first graphical component representing one of said first classroom data objects,
the database of classroom data further includes a list of one or more second classroom data objects, each second classroom data object further includes a list of one or more first classroom data objects,
said graphical user interface further includes a second graphical component representing one of said second classroom data objects,
wherein, when the first graphical component is dropped on the second graphical component, said first classroom data object is added to the list of said second classroom data objects.

3. The system of claim 2 wherein the first data object is a student data object that identifies a first student, the second data object is a first course data object that identifies a first course, wherein, wherein, when the first graphical component is dropped on the second graphical component, said first student becomes a logical member of the first course.

4. The system of claim 3 wherein the first data object is a teacher data object that identifies a first teacher, the second data object is a second course data object that identifies a second course, wherein, when the first graphical component is dropped on the second graphical component, said first teacher becomes a logical teacher of the second course.

5. The system of claim 2 wherein the first data object is a teacher data object that identifies a first teacher, the second data object is a second course data object that identifies a second course, wherein, when the first graphical component is dropped on the second graphical component, said first teacher becomes a logical teacher of the second course.

6. A system for managing classroom data comprising:
a graphical user interface,
the database of classroom data further includes a list of one or more first classroom data objects,
said graphical user interface further includes a first graphical component representing one of said first classroom data objects,
the database of classroom data further includes a list of one or more second classroom data objects, each second classroom data object further includes a list of one or more first classroom data objects,
said graphical user interface further includes a second graphical component representing one of said second classroom data objects,
wherein, when the first graphical component is dropped on the second graphical component, said first classroom data object is added to the list of said second classroom data objects.

7. The system of claim 6 wherein the first data object is a student data object that identifies a first student, the second data object is a first course data object that identifies a first course, wherein, wherein, when the first graphical component is dropped on the second graphical component, said first student becomes a logical member of the first course.

8. The system of claim 6 wherein the first data object is a teacher data object that identifies a first teacher, the second data object is a second course data object that identifies a second course, wherein, when the first graphical component is dropped on the second graphical component, said first teacher becomes a logical teacher of the second course.

9. A system for managing a dataset representing a mobile population comprising:
a hierarchy of child nodes including a root node, each node has an associated classroom data object, each child node of the hierarchy, except the root node, identifies another child node in the dataset as its parent node,
each child node further includes a security token, the security token further includes authorization codes, wherein a user that presents said authorization codes is authorized to move data related to any and all descendant child nodes.
